(19) United States
(12) Patent Application Publication
(10) Pub. No.: US 2006/0012281 A1
(43) Pub. Date: Jan. 19, 2006

(54) Carbon nanotube field emitter and method for producing same

(76) Inventors: Nyan-Hwa Tai, Hsin Chu City (TW); I-Nan Lin, Taipei (TW); Tsung-Yen Tsai, Chang Hua County (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/893,667

(22) Filed: Jul. 16, 2004

(51) Int. Cl. H01J 1/14

(52) U.S. Cl. 313/311

(57) ABSTRACT

A carbon nanotube electrode includes a plurality of carbon nanotubes as the electron emitter. The manufacturing method involves the preparation of a carbon nanotube paste, screen printing circuits onto a substrate for forming integrated circuits after sintering, screen printing a carbon nanotube with the carbon nanotube paste onto the substrate to form an emitter source, and going through a thermal treatment process and a sintering process to obtain a good-quality carbon nanotube electrode with a threshold voltage lower than 1.9 V/μm.

### BACKGROUND OF THE INVENTION

1. Field of the Invention

The present invention relates to a field emitter, more particularly to a field electrode that uses a carbon nanotube as the emitter source and its manufacturing method.

2. Description of the Related Art

In general, various materials including metal spindts and thin diamond films used for field emitters require a very high threshold field (i.e. the electric field required for the current density of Je=10 mA/cm²) before accomplishing good performance. Many technical literatures and journals have shown that better performance can be obtained if the carbon nanotube is applied to field emitters. It shows that the carbon nanotube is an excellent material for manufacturing field emitters.

At present, the field emitter using carbon nanotubes as an electron emitter source is generally produced by growing carbon nanotubes directly on a substrate and then adding appropriately designed components to form the desired electronic emitter source. This method comprises the steps of placing a catalyst on a substrate to directly grow carbon nanofibers or carbon nanotubes as the electron emitter source. A further improvement is to produce an carbon nanotube array, thus the electron emission performance of the carbon nanotubes can be achieved.

In the U.S. Pat. No. 6,436,221, nanotubes, organic bonding agent, resin and silver power are mixed to form a carbon nanotube paste, and the carbon nanotube paste is coated onto a flat type emitter by a screen printing method to serve as an electron emitter source. However, experiments show that the device obtained by such method can have a current density of 10 mA/cm² only if the electric field exceeds 4.5 V/μm. Furthermore, the U.S. Pat. No. 6,146,230 disclosed a composition for an electron emitter that comprises electron emitting materials including a polyoxyethylene nonyl phenyl ether derivative or polyvinylpyrrolidone as the dispersion agent, and a silane based compound or a colloidal silica mixed with graphite powder, diamond-like-carbon powder, carbon nanotubes, carbon fiber powder, boron nitride, or aluminum nitride as the binder. However, the technological claims of this patent have not been supported by related experiment data yet.

In general, the aforementioned patented inventions may be able to produce a electrode that uses carbon nanotubes as an electron emitter source, but all of them have the shortcomings of requiring complicated manufacturing processes and high manufacturing costs. Although the U.S. Pat. No. 6,146,230 proposed a simple and low-cost manufacturing process, no related experiments or data supports its achievements. Furthermore, the electrode so produced shown a higher threshold field.

Therefore, one of the difficult topics for researchers and manufacturers to overcome is to develop a simple manufacturing process with low costs for producing high performce electrode.

### SUMMARY OF THE INVENTION

It is therefore a primary objective of the present invention to provide a simple and low-cost manufacturing process to manufacture an electrode that uses the carbon nanotube as the electron emitter source.

The method for manufacturing a field emission carbon nanotube emitter comprises the steps of:
(a) using a low-temperature co-fire ceramic sintering process to produce a substrate having highly integrated internal circuits;
(b) preparing a carbon nanotube paste and screen printing the carbon nanotube paste onto the substrate to form at least one emitter source;
(c) heat treated the product produced in Step (b); and
(d) sintering the product produced in Step (c).

Further, the field emission carbon nanotube emitter produced by the foregoing method according to the present invention comprises a highly integrated ceramic substrate and an emitter source formed on the highly integrated ceramic substrate.

The highly integrated ceramic substrate is produced by a low-temperature co-fire ceramic sintering process.

The emitter source is ring-shaped by screen printing a carbon nanotube paste made by a carbon nanomaterial and a silver paste containing silver nanopowder. If a voltage is applied to the emitter source, a plurality of electrons will be emitted.

To make it easier for our examiner to understand the objective of the invention, its structure, innovative features, and performance, we use a preferred embodiment including but not limited to the attached drawings for the detailed description of the invention.

### BRIEF DESCRIPTION OF THE DRAWINGS

FIG. 1 is a flow chart of the method for fabricating carbon nanotube electrode according to a preferred embodiment of the present invention.

FIG. 2 is a top view of the carbon nanotube electrode fabricated according to the method as depicted in FIG. 1.

FIG. 3 is a cross-sectional view of the carbon nanotube electrode fabricated according to the method as depicted in FIGS. 1 and 2.

FIG. 4 is a SEM picture illustrating the dispersion situation between the carbon nanotubes and the silver powder obtained using a common carbon nanotube paste without adding any silver nanopowder.

FIG. 5 is a SEM picture illustrating a cross-sectional image of the non-uniform dispersion of the silver powder that causes a drop of electrical conductivity.

FIG. 6 is a SEM picture illustrating the dispersion of the nanotubes fabricated by the silver nanotube paste containing silver nanopowder according to the present invention.

FIG. 7 is a SEM image od side view of the electrode as depicted in FIG. 6 illustrating the uniform dispersion between the nanotubes and the silver nanopowder.

FIG. 8 is the plot of the measurement results for comparing the field emission efficiency of the electrode produced by a common nanotube paste without mixing with silver nanopowder and the electrode produced by the nanotube paste mixed with silver nanopowder according to the present invention.

FIG. 9 is a photo of the light emitter involved the carbon nanotube electrode of the present invention that uses a fluorescent body as an anode for the fabrication and operates at the voltage of 300V.

FIG. 10 is a photo of the light emitter involved the carbon nanotube electrode of the present invention that uses a fluorescent body as an anode for the fabrication and operates at the voltage of 400V.

FIG. 11 is a plots of the measurement result for the field emission efficiency of the carbon nanotube electrode that is produced by the nanotube paste mixed with a 10 wt % of the carbon nanomaterial and operated within the operating voltage range of 0˜600V according to the present invention.

### DETAILED DESCRIPTION OF THE PREFERRED EMBODIMENTS

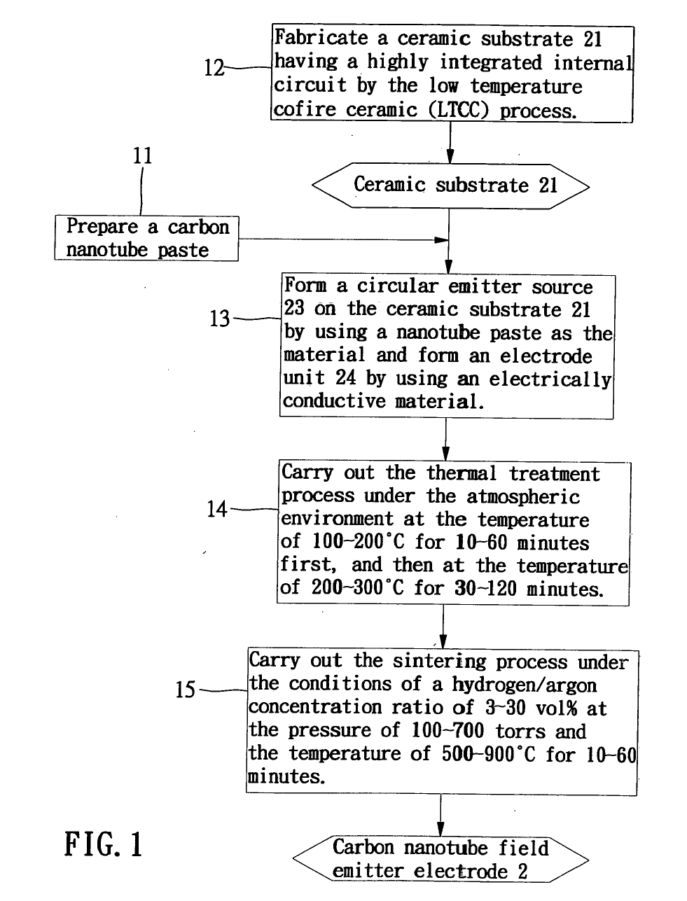

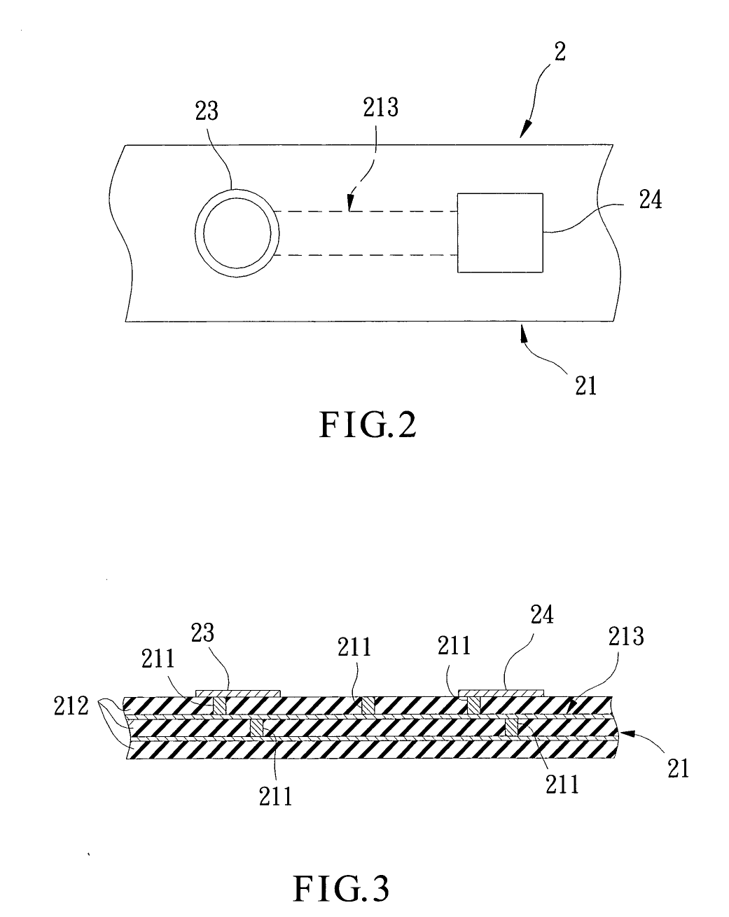

Referring to FIG. 1 for a method for producing a carbon nanotube electrode according to a preferred embodiment of the present invention, the carbon nanotube electrode 2 so produced as shown in FIG. 2 can be used for a field emitting display or a light emitting device, etc.

In the meantime, referring to FIGS. 2 and 3 for the carbon nanotube electrode 2, which comprises a ceramic substrate 21, an electrode unit 24 formed on the ceramic substrate 21 and an emitter source 23 formed on the ceramic substrate 21.

The ceramic substrate 21 is an integrated ceramic substrate comprising at least two vias 211 for an electrical connection and an internal circuit 213 formed between two ceramic tapes 212 and a plurality of vias 211. The internal circuit also can be substituted by adopting a conductive layer produced by an electrically conductive material.

The electrode base 24 is produced by an electrically conductive material such as a silver paste and electrically connected to the internal circuit 213 and thus applying the voltage onto the emitter source 23.

A carbon nanotube paste (which is made by a carbon nanomaterial and a silver paste containing silver nanopowder) are used for the screen printing method to produce an emitter source 23 having a circular shape and a width ranging from 50 μm to 400 μm. When a voltage is applied onto the electrode base 24, each carbon nanotube in the carbon nanomaterial can be sued as an electron emitter.

A macroscopic view of the structure of the carbon nanotube field emitter will be described briefly as follows first, and the manufacturing method and related experiment results will be elaborated in details.

Referring to FIG. 1, the fabrication of the carbon nanotube electrode 2 including the preparation of a carbon nanotube paste containing a plurality of carbon nanotubes. In this embodiment, the chemical vapor deposition process is applied to synthesize the carbon nanotubes, in the process, a carbon-based precursor such as xylene, cyclohexene, methylbenzene, benzene or n-hexane is mixed with ferrocene as a catalyst and thiophene as a promoter to synthesize multi-wall carbon nanotubes with a diameter in the range of 20˜250 nm.

A silver paste, containing silver powder with a particle diameter of 0.15˜5 μm, which is commercial available in the market (this invention adopts the MEP-AG-PTG-5575) is mixed uniformly with a silver nanopowder having a particle diameter of 30˜150 μm to produce a mixture. The silver content in the silver paste is 30˜100 wt % (percentage by weight). Finally, the carbon nanomaterial with the additive amount of 1˜15 wt % is mixed with the silver paste (containing silver nanopowder) (with the additive amount of 99˜85 wt %). A surfactant (Triton X-100 in this invention) with the amount ranging from 0.8 to 1.8 ml/g is used to produce the nanotube paste.

Of course, it is not compulsory to produce the carbon nanomaterial on your own. Any multi-wall nanotube having a diameter of 20˜150 nm or any carbon nanofiber having a diameter of 50˜500 nm may be used as the carbon nanomaterial for this invention. In addition, the reactive surfactant is not limited to Triton X-100, but any solvent with equivalent functions can be used as a substitute.

On the other hand, process 12 can be carried out for producing a highly integrated ceramic substrate 21. In the low temperature cofire ceramic (LTCC) process, a mixture of glass and aluminum oxide powder or a mixed compound material of aluminum oxide fibers is adopted as the material to produce a ceramic paste, and then a plurality of thin ceramic tapes is formed by the tape casting method, and a plurality of tape vias 211 are produced by laser. After the vias are filled, an electrically conductive material such as a silver paste is screen printed to produce an internal circuit (or an electrically conductive layer) 213. Finally, these screen printed internal circuits (or electrically conductive layers) 213 go through the process of stacking the ceramic tapes 212, and the hot pressing and annealing processes are then applied to fabricate the ceramic substrate 21 by a low-cost and precise manufacturing process, so that the ceramic substrate 21 not only has highly integrated internal circuits (or electrically conductive layers) for integrating various different components, but also offers a high temperature resisting to bear with the follow-up thermal processes.

Then, another process 13 is carried out to form a circular emitter source 23 on the ceramic substrate 21 by screen printing the carbon nanotube paste prepared in the process 11, and the external diameter of the circular emitter source 23 is in the range of 1200 μm˜2000 μm and the width in the range of 150 μm˜1500 μm. A silver paste is used as the material to form an electrode base 24. It is noteworthy that the shape of the emitter source is not limited to the circular shape, and any rectangular, triangular or polygonal shapes can be used to achieve the expected effect of the present invention. A circular shape with a radius in the range of 500˜5000 μm can also achieve the expected result.

A heat treatment process 14 is performed in the atmospheric environment at the temperature of 110˜220° C. for 10˜60 minutes first, and then at a temperature of 200˜300° C. for 30˜120 minutes.

Finally, a sintering process 15 is performed under oxygen/argon atmosphere with the concentration ratio of 3˜30 vol % (by volume) under a temperature in the range of 500˜900° C. and a pressure in the range of 100˜700 torrs for 10˜60 minutes. The foregoing processes are thus carried out to produce the carbon nanotube electrode 2.

It is noteworthy that after the circular emitter source 23 is formed, a substance capable of guiding the movement of electrons or a substance having a high dielectric constant including platinum, palladium, iron, cobalt and nickel metals, or an alloy consisting these metal elements can be used to fill the space enclosed by the circular emitter source 23 for affecting the movement of electrons in order to enhance the field emission efficiency.

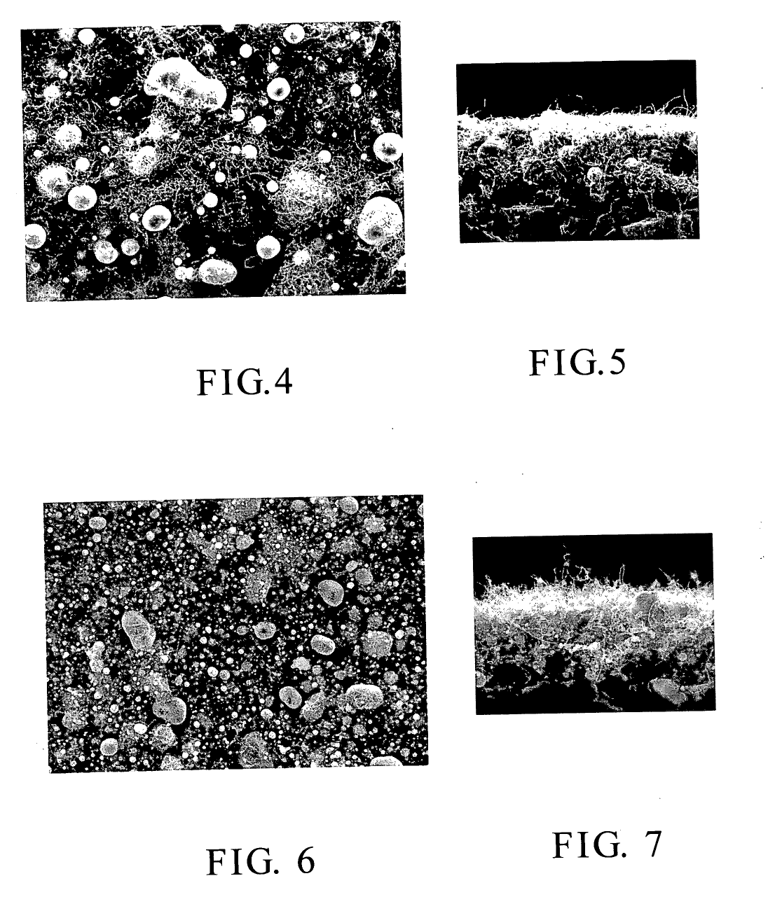

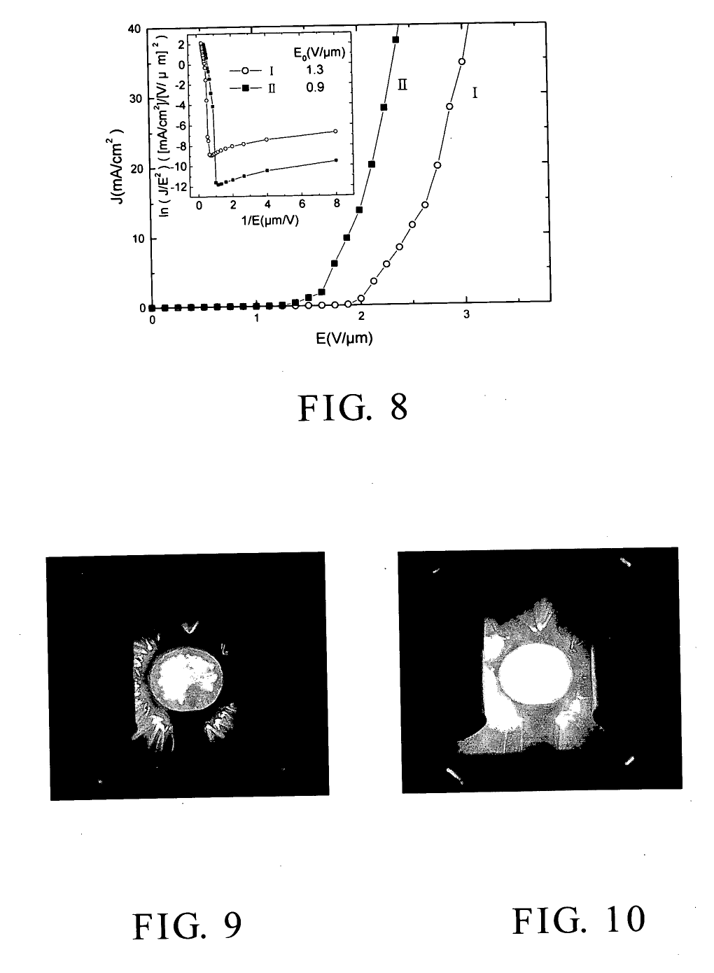

The carbon tube paste without mixing silver nanopowder (such as the commercialized silver paste) and the carbon nanotube paste mixed with silver nanopowder according to the present invention are used. After the screen printing, a soft baking, sintering, and annealing processes as described in the processes 14 and 15 are applied. It is obvious that the dispersion of the carbon tube paste without being mixed with silver nanopowder, as shown in FIGS. 4 and 5, indicates non-uniform distribution of carbon nanotubes in silver particles. The dispersion of the silver nanotube paste mixed with silver nanopowder according to the present invention as shown in FIGS. 6 and 7, indicates an uniform distribution. The uniformity of carbon nanotube paste can improve the electrical conductivity of the electrode. Referring to FIG. 8. the carbon nanotube paste with silver nanopowder according to the present invention definitely perform a better field emission efficiency.

Referring to FIGS. 9 and 10, the fabricated carbon nanotube electrode 2 according to the present invention is used as cathode, and indium tin oxide (ITO) glass coated with a fluorescent powder is used as an anode. FIGS. 9 and 10 show the light emission performance of the light emitting device measured at the operating voltages of 300V and 400V, respectively. It is obvious that a larger light emitting area is obtained by the circular field emitter 23 according to the present invention.

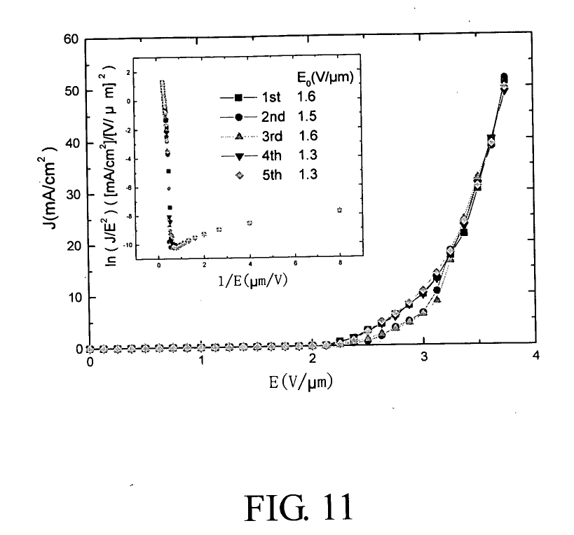

Based on the results shown in FIG. 11, the carbon nanotube electrode produced by a carbon nanotube paste containing 10 wt % of carbon nanotube with an external diameter of 3.1 mm and a width of 0.25 mm shown has an outstanding field emission efficiency.

In summation of the description above, since the carbon nanotube has a high inertia, a high electrical conductivity, and very small radius of curvature, therefore it is very suitable to be used as a material for fabricating a field emitter. The present invention adopts ceramic plate as the substrate and prepares multi-wall carbon nanotubes paste. The screen printing process for producing electron emitter source on carbon nanotube electrode is performed. The present invention not only fabricates a carbon nanotube electrode with highly integrated internal circuits, but also produces a carbon nanotube electrode having lower threshold voltage and better field emission efficiency. The present invention also involves simple manufacturing processes, low production cost for the field emitter manufacturing process for fabricating carbon nanotube electrode with high field emission efficiency.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements.

1. A carbon nanotube paste for manufacturing a carbon nanotube electrode, comprising:
a carbon nanomaterial; and
a conductive paste, containing metal nanopowder.

2. A carbon nanotube paste for manufacturing a carbon nanotube electrode as claimed in claim 1, wherein said carbon nanomaterial and said conductive paste have a ratio of 1˜15 wt %: 99˜85 wt % by weight.

3. A carbon nanotube paste for manufacturing a carbon nanotube electrode as claimed in claim 2, wherein said carbon nanomaterial is a product comprising a plurality of multi-wall carbon nanotubes, carbon nanofiber, or single wall carbon nanotubes.

4. A carbon nanotube paste for manufacturing a carbon nanotube electrode as claimed in claim 3, wherein said multi-wall carbon nanotubes have a diameter in the range of 15˜150 nm.

5. A carbon nanotube paste for manufacturing a carbon nanotube electrode as claimed in claim 2, wherein said carbon nanomaterial is a carbon nanofiber with a diameter in the range of 50˜500 nm.

6. A carbon nanotube paste for manufacturing a carbon nanotube electrode as claimed in claim 2, wherein said carbon nanomaterial is a single wall carbon nanotubes with a diameter in the range of 0.7˜4.0 nm.

7. A carbon nanotube paste for manufacturing a carbon nanotube electrode as claimed in claim 1, wherein said metal nanopowder has a particle diameter in the range of 0.10˜5.0 μm.

8. A carbon nanotube paste for manufacturing a carbon nanotube electrode as claimed in claim 1, wherein said metal nanopowder has a particle diameter in the range of 5˜100 nm.

9. A carbon nanotube paste for manufacturing a carbon nanotube electrode as claimed in claim 8, wherein said metal nanopowder has a metal content of 30˜100 wt % of said conductive paste by weight.

10. A method for producing a carbon nanotube electrode comprising: providing a substrate; and screen printing a carbon nanotube paste onto the substrate.

11. The method for producing a carbon nanotube electrode as claimed in claim 29, wherein providing the substrate comprises providing the substrate with said electrically conductive material in the form of a conductive paste.

12. The method for producing a carbon nanotube electrode as claimed in claim 10, wherein screen printing comprises screen printing in the form of at least one emitter source, wherein said emitter source has a circular shape, said circular shape has an external diameter in the range of 1200˜2000 μm and a width in the range of 100 μm 500 μm.

13. The method for producing carbon nanotube electrode as claimed in claim 10, wherein screen printing comprises screen printing in the form of at least one emitter source having a shape selected from a circular shape, a rectangular shape, a triangular shape, and a polygonal shape.

14. The method for producing carbon nanotube electrode as claimed in claim 12, wherein screen printing comprises screen printing in the form of at least one emitter source being circular in shape and having a radius in the range of 500˜1500 μm.

15. The method for producing a carbon nanotube field emitter as claimed in claim 10, wherein screen printing comprises screen printing in the form of at least one circular emitter source forming a filling space enclosed by said at least one emitter source, with the method further comprising filling the filling space with a substance capable of affecting the movement of electrons.

16. A carbon nanotube electrode, comprising:
a substrate; and
a circular emitter source, formed on said substrate by screen printing a carbon nanotube paste produced by a carbon nanomaterial and conductive paste containing silver nanopowder, thereby said circular emitter source emits a plurality of electrons when a voltage is applied.

17. The carbon nanotube electrode as claimed in claim 16, wherein said substrate comprises at least two thin ceramic tapes having a plurality of vias and an internal circuit formed with a predetermined mode and disposed between said two thin ceramic tapes and said plurality of vias.

18. The carbon nanotube field emitter as claimed in claim 16, wherein said substrate comprises at least two thin ceramic tapes having a plurality of vias and an electrically conductive layer formed with a predetermined mode and disposed between said two thin ceramic tapes and said plurality of vias.

19. The carbon nanotube field emitter as claimed in claim 16, wherein said circular emitter source has a outer diameter in the range of 600 μm˜2000 μm and a width in the range of 150 μm˜500 μm.

20. (canceled)

21. The carbon nanotube electrode as claimed in claim 16, wherein said carbon nanomaterial comprises a plurality of multi-wall carbon nanotubes, carbon nanofibers, or single wall carbon nanotubes, one dimensional carbon material is an electronic emitter for emitting electrons when an external voltage is applied.

22. The carbon nanotube electrode as claimed in claim 21, wherein each said multi-wall carbon nanotube has a diameter falling in the range of 20˜150 nm.

23. The carbon nanotube electrode as claimed in claim 16, wherein said carbon nanomaterial comprises a plurality of carbon nanofibers with a diameter in the range of 50˜500 nm.

24. The carbon nanotube electrode as claimed in claim 16, wherein said carbon nanomaterial comprises a plurality of single wall carbon nanotubes with a diameter in the range of 0.7˜4.0 nm.

25. The carbon nanotube field emitter as claimed in claim 16, wherein said silver paste comprises silver powder with a particle diameter falling in the range of 0.1˜5 μm.

26. The carbon nanotube electrode as claimed in claim 16, wherein said silver paste contains silver nanopowder with a particle diameter falling in the range of 30˜150 nm.

27. The carbon nanotube electrode as claimed in claim 16, wherein said silver nanopowder has a silver content of 30˜100 wt % of said silver paste by weight.

28. (canceled)

29. The method of claim 10 wherein providing the substrate comprises providing the substrate with electrically conductive material therein for forming an integrated internal circuit.

30. The method of claim 10 wherein providing the substrate comprises providing the substrate which is plain.
